(19) United States
(12) Patent Application Publication
(10) Pub. No.: US 2010/0324993 A1
(43) Pub. Date: Dec. 23, 2010

(54) PROMOTIONAL CONTENT PRESENTATION BASED ON SEARCH QUERY

(75) Inventors: Varun Kacholia, Sunnyvale, CA (US); Kedar Dhamdhere, Sunnyvale, CA (US); Sugato Basu, Redwood City, CA (US)

Correspondence Address: FISH & RICHARDSON P.C., PO BOX 1022, MINNEAPOLIS, MN, 55440-1022, US

(73) Assignee: Google Inc., Mountain View, CA (US)

(21) Appl. No.: 12/488,426

(22) Filed: Jun. 19, 2009

(51) Int. Cl. G06Q 30/00; G06F 17/30

(52) U.S. Cl. 705/14.54; 705/14.73; 707/759; 707/769; 707/673; 707/706; 707/709

(57) ABSTRACT

In a computer-implemented method of providing digital content, a plurality of web pages is identified, where each of the identified web pages has an associated benefit to be accrued as a result of activity by a user on the identified web page. A search query that includes a search term is received, and one or more of the identified web pages is selected based on the benefits to be accrued as the result of the activity on the identified web pages and a relationship between the identified web pages and the search term. Representations of the selected one or more of the identified web pages are displayed on a display device.

### TECHNICAL FIELD

This disclosure generally relates to information retrieval and presentation.

### BACKGROUND

The rise of interactive media, such as the Internet, has enabled access to a wide variety of digital content items, including, for example, video and/or audio files, web pages for particular subjects, and news articles. Such access to these digital content items has likewise enabled opportunities for targeted content presentation. For example, content items of particular interest to a user can be identified by a search engine in response to a user query. One example search engine is the Google search engine provided by Google Inc. of Mountain View, Calif., U.S.A. The query can include one or more search terms, and the search engine can identify and, optionally, rank the content items based on the search terms in the query and present the content items to the user (e.g., according to the rank). The query can also be compared to a list of keywords specified by an advertiser. By comparing the received query to a list of keywords specified by an advertiser, it is possible to provide targeted advertisements to the user.

Another form of online advertising is advertisement syndication, which allows advertisers to extend their marketing reach by distributing advertisements to additional partners. For example, third party online publishers can place an advertiser's text or image advertisements on web pages that have content related to the advertisement. The advertisements can include embedding links to landing pages, e.g., a page on an advertiser's website that a user is directed to when the user clicks on an advertisement presented on the publisher's web page. As the users are likely to be interested in the particular content on the publisher's web page, they are also likely to be interested in the product or service featured in the advertisement. Accordingly, such targeted advertisement placement can help drive online customers to the advertiser's website.

### SUMMARY

This disclosure describes methods, systems, and devices that can be used to provide informative and useful digital content that is relevant to a received search query.

In a first general aspect, a computer-implemented method of providing digital content includes identifying a plurality of web pages, where each of the identified web pages has an associated benefit to be accrued as a result of activity by a user on the identified web page. The method also includes receiving a search query that includes a search term and selecting one or more of the identified web pages based on the benefits to be accrued as the result of the activity on the identified web pages and a relationship between the identified web pages and the search term. The method further includes displaying on a display device representations of the selected one or more of the identified web pages.

Implementations can include one or more of the following. Each of the identified web pages may include an advertisement, and the activity on the identified web page may include an action associated with the advertisement. The advertisement may be a selectable advertisement, and the activity may be a selection of the selectable advertisement. Selecting one or more of the identified web pages may include searching the index and identifying web pages relevant to the search term. The relationship between the selected one or more of the identified web pages and the search term may include relevancy. The method may further include maintaining an index of the identified web pages or displaying on the display device, separate from the representations of the selected one or more of the identified web pages, search results for the search query. The method may further include identifying a plurality of digital content items, each having an associated benefit that is accrued as a result of displaying the digital content item. Each of the digital content items may have an associated quality score, and the method may include determining whether the associated quality score for a predetermined number of the digital content items exceeds a minimum quality score associated with a presentation opportunity, wherein the predetermined number is a number of positions associated with a content queue for the presentation opportunity. The representations of the selected one or more of the identified web pages may be used to fill any content queue positions not filled by the digital content items.

In a second general aspect, a system includes a content identification module configured to identify a plurality of web pages, where each of the identified web pages has an associated benefit to be accrued as a result of activity by a user on the identified web page. The system also includes a content serving module configured to receive a search query comprising a search term, select one or more of the identified web pages based on the benefits to be accrued as the result of the activity on the identified web pages and a relationship between the identified web pages and the search term, and display on a display device representations of the selected one or more of the identified web pages.

Implementations can include one or more of the following. Each of the identified web pages may include an advertisement, and the activity on the identified web page may include an action associated with the advertisement. The advertisement may be a selectable advertisement, and the activity may be a selection of the selectable advertisement. The content identification module may be further configured to maintain an index of the identified web pages. Selecting one or more of the identified web pages may include searching the index and identifying web pages relevant to the search term. The system may further include a search results module configured to identify search results for the search query, and the content serving module may display on the display device, separate from the representations of the selected one or more of the identified web pages, the search results for the search query. The relationship between the selected one or more of the identified web pages and the search term may include relevancy. The content serving module may be further configured to identify a plurality of digital content items, each having an associated benefit that is accrued as a result of displaying the digital content item. Each of the digital content items may have an associated quality score, and the content serving module may be further configured to determine whether the associated quality score for a predetermined number of the digital content items exceeds a minimum quality score associated with a presentation opportunity, where the predetermined number is a number of positions associated with a content queue for the presentation opportunity. The representations of the selected one or more of the identified web pages may be used to fill any content queue positions not filled by the digital content items.

In a third general aspect, a computer-implemented method of providing digital content includes identifying a plurality of web pages, where each of the identified web pages has an associated benefit to be accrued as a result of activity by a user on the identified web page. The method also includes receiving a search query comprising a search term, and means for selecting one or more of the identified web pages based on the benefits to be accrued as the result of the activity on the identified web pages and a relationship between the identified web pages and the search term. The method further includes displaying on a display device representations of the selected one or more of the identified web pages.

Implementations may provide one or more of the following advantages. Additional useful digital content may be provided. Digital content relevant to a user-supplied term may be provided. Opportunities for increased revenue generation may result from a larger inventory of digital content for presentation based on a received search query. Web site traffic may be increased. Relationships with publishers may be strengthened by providing the publisher additional exposure to interactive media users. Increased depth and breadth of digital content provision may be realized as additional candidate web pages are identified and considered for presentation.

The details of one or more implementations are set forth in the accompanying drawings and the description below. Other features and advantages will be apparent from the description and drawings as well as from the claims.

### BRIEF DESCRIPTION OF THE DRAWINGS

FIG. 1 is a block diagram depicting an example online environment.

FIG. 2 is a screen shot depicting example search query results combined with promotional content.

FIG. 3 is a flow diagram of an example process for providing digital content.

FIG. 4 is a flow diagram of another example process for providing digital content.

FIG. 5 is a block diagram of an example promotional content management system.

FIG. 6 is a diagram of an example generic computer device and an example generic mobile computer device.

### DESCRIPTION

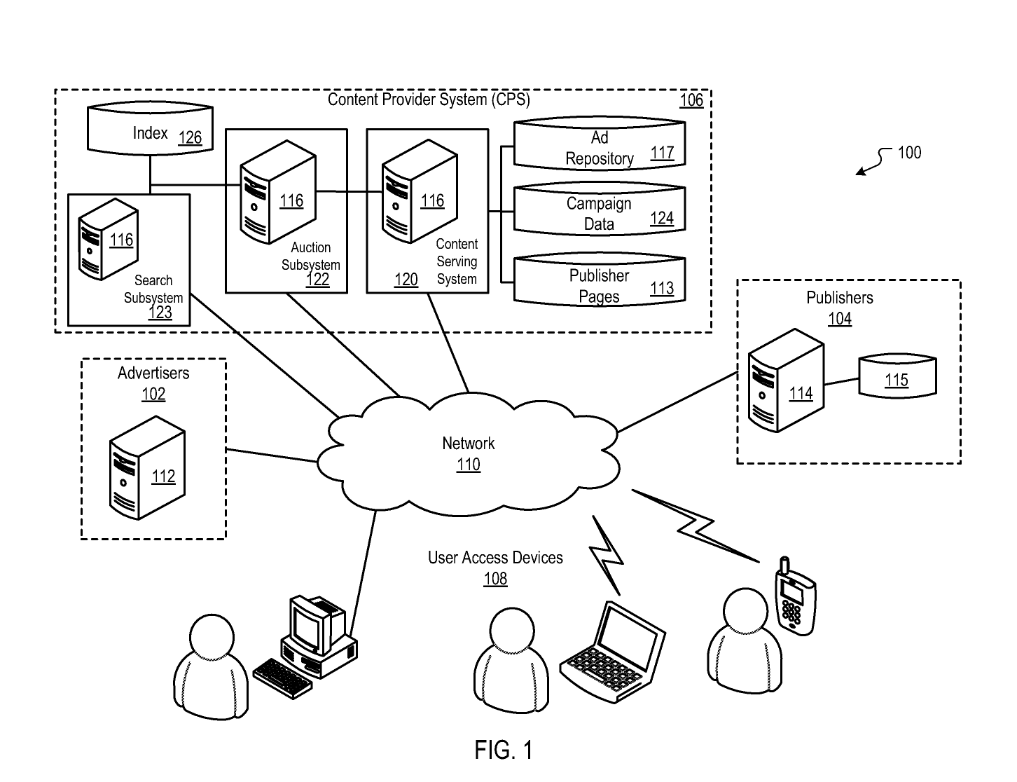

Referring to FIG. 1, an online environment 100 can facilitate identification and service of digital content items, such as web pages, links, images, advertisements, discussion threads, and other media, to users. As described in detail below, the environment 100 can analyze search engine index data and search query data to suggest relevant digital content items for display on a display device. In various implementations, the environment 100 can suggest relevant digital contents items for display together with, alongside, in concert with, or to supplement a presentation of search results.

In general, the environment 100 can be used to increase an inventory of candidate digital content items that may be presented in response to receipt of a search query. The candidate digital content items can include promotional content, such as advertisements for which advertisers provide monetary incentive to promote presentation of the advertisements, as by bidding on keywords associated with the advertisements to encourage a content provider to present or serve the advertisements. Another type of candidate promotional content is a web page having an advertisement on a portion of the page, but for which the publisher of the web page or the advertiser associated with the advertisement has not provided a monetary incentive based solely on presentation of the page (or a representation of the page). The publisher may nevertheless have a relationship or affiliation with the content provider regarding the advertisement appearing on the associated web page, as will be described more fully below. These two types of candidate items will be referred to as “type-1” content items that include a financial incentive for mere presentation, and “type-2” content items that do not include a financial incentive for mere presentation.

In general, a content provider may present (e.g., for display) type-1 content items, type-2 content items, or a mixture of type-1 and type-2 content items, as well as other content in various implementations. For example, general search results may be presented in addition to presentation of type-1 content items, type-2 content items, or both type-1 and type-2 content items. For type-2 content items, the publishers may choose not to bid on keywords associated with either the web page or the one or more advertisements included thereon, for various reasons. These various types of candidate digital content items can be managed separately in some implementations, as by maintaining separate indices for each, which may be separately searchable in some implementations. In other examples, content items of various types may be indexed in one or more indices with coverage overlap.

The web pages maintained by the publishers, which may be referred to as publisher pages, may include advertisements, such as banner advertisements displayed on portions of the web pages. When the advertisement is selected, as by a user selection of the advertisement with a pointing device, a landing page of the advertisement may be served for presentation. In various implementations, the publishers may accrue a monetary credit, payable by the advertiser, when this occurs. In some implementations, the publishers may have a relationship or affiliation with a content provider, whereby the content provider identifies and provides appropriate advertisements for display on the publisher's web page. This can relieve the publisher from having to solicit and manage advertising to, for example, determine which advertisements are appropriate for inclusion on the web page, which may allow the publisher to focus on its business of providing content. In some implementations, the content provider may not select advertisements for the publisher, but may present the publisher's page that includes an advertisement.

The relationship may, in return, call for the publisher or alternatively the advertiser associated with the advertisement to compensate the content provider in various ways. For example, the content provider may accrue a benefit as a result of activity on the publisher's page (which includes the advertisement) following presentation of the page by the content provider. One example of such an activity may be a selection of the advertisement on the publisher page. As another example, the content provider may accrue a benefit as a function of a number of presentations of the publisher page or representations of the publisher page that includes an advertisement.

With respect to presentation of promotional content, benefits or levels of benefit accrued by the content provider may differ according to the type of content presented. For example, content items may be classified into two or more types based on a compensation schedule associated with the type of content item. Within each classification type, monetary amounts or benefits accrued by the content provider may vary, for example, but content items within a classification type may share a monetization method or scheme that defines how the content provider is compensated (e.g., by an advertiser or publisher) for presentation of, or for activity associated with, the content items.

The type-1 content items discussed above may be referred to as being “actively subscribed-to” by an entity (e.g., an advertiser or publisher), because the entity may provide direct financial incentive for a content provider to present the type-1 content items. In like fashion, the type-2 content items discussed above may be referred to as “not actively subscribed-to” by an entity because no direct financial incentive may be provided for mere presentation of the type-2 content item. An example of an incentive associated with type-1 items can include a promised payment. That is, the content provider may accrue a benefit (e.g., a promise to pay a particular monetary amount) upon presentation of the type-1 content item (e.g., advertisement) or a representation of the content item. As one example, advertisers may bid on one or more keywords associated with an advertisement to increase exposure of the advertisement, and the content provider may consider various bids in determining which content items to present. Exposure of the advertisement may be increased, for example, if the content provider presents the advertisement more frequently.

Type-2 content items can include web pages or publisher pages that may include an advertisement (e.g., a banner or text ad), but for which a direct presentation incentive (e.g., based merely on presentation) for the content provider is lacking. Despite not having a financial incentive that rewards mere presentation of type-2 content items, the content provider may nevertheless have opportunities to accrue benefits associated with type-2 content items. As described above, type-2 content items can be associated with entities that may be affiliated with the content provider. The affiliation may include an agreement between the content provider and the entity that provides for compensation to the content provider based on certain conditions. For example, the content provider may accrue a benefit based on activity associated with the type-2 content item. The agreement may call for the entity to compensate the content provider when an advertisement on a web page associated with the entity is selected following service of the web page (or a representation of the web page) by the content provider.

Alternatively, other types of activity with respect to type-2 content items may trigger benefit accrual by the content provider, such as activity or an indication of heightened interest in the advertisement. Examples of activities indicative of heightened interest in the advertisement (or alternatively in the publisher page) can include a “conversion,” which may occur when a user consummates a transaction related to a given ad. A conversion could be defined to occur when a user clicks on an ad, is referred to the advertiser's (or affiliated publisher's) web page, and consummates a purchase there before leaving that web page. In another example, a conversion could be defined as the display of an ad to a user and a corresponding purchase on the advertiser's web page within a predetermined time (e.g., seven days). Other examples that could trigger a benefit accrual can include one or more selections from a landing page or another page associated with the advertisement, viewing the advertisement for at least a minimum period of time, copying or forwarding an identifier (e.g., a URL address) associated with the advertisement or publisher page, and the like.

In some implementations, given a choice of presenting a type-1 content item or a type-2 content item, it may be more lucrative for the content provider to present a type-1 content item. However, in some implementations, inventory of appropriate and relevant type-1 content items may be insufficient for a given presentation opportunity, whether in quantity of available appropriate content items, quality of available content items, or both. In these and other cases, it may be beneficial to supplement or replace presentation of content items of the first type with presentation of content items of the second type. In some implementations, it may be more lucrative or preferable for other reasons to present type-2 content items in lieu of type-1 content items, for example. For example, some users may prefer presentation of content that is less overtly promotional, and may prefer content items such as publisher pages (which may include an advertisement) to a dedicated advertisement.

In various implementations, in response to a received search query (or other indication of information), a predetermined number of content items may be desired to fill a content queue that may represent, for current or future presentation or delivery, a predetermined number of available content presentation locations or positions in, for example, a display, a database, a document, a report, a message, a table, a record, or a list. The environment 100 can be used to populate or fill-out a content queue (e.g., positions or slots for representations of promotional content, ad space, or a sponsored links section) by selecting and delivering relevant digital content items to, for example, a display or database. By increasing the number of candidate digital content items that may be presented in response to receipt of a search query, an enhanced user experience may be provided as the user may be presented with a wider variety of relevant, timely, and interesting content.

In some implementations, a user may be presented with multiple types of information in response to a provided search query. For example, the user may be provided with a list of search results in one area of a display, and may be provided with promotional content, or pages (or representations of pages) that include promotional content, in another area of the display. In some implementations, search results and promotional content may be presented in the same area of the display, in any appropriate presentation style. In various implementations, one or more of the search results and the promotional content may be labeled to identify the type of information being presented in each area of the display. For example, a “sponsored links” section and a “search results” section may indicate promotional content and search results, respectively.

Increasing an inventory of candidate digital content items or content sources for presentation may generally increase an amount of content that can be monetized by a content provider, which can lead to increased revenue generation for the content provider. Additionally, quality of presented information may be improved as additional candidate content items are identified and available for presentation. For example, depth and breadth of relevant and material information may be improved by expanding a scope of content consideration for presentation in response to receipt of a search query. Publishers and advertisers may similarly benefit by increased traffic to their web sites and increased exposure of their content to potentially receptive audiences.

An advertisement or an “ad” may refer to any form of communication in which one or more products, services, ideas, messages, people, organizations, or other items are identified and promoted or otherwise communicated. Ads are not limited to commercial promotions or other communications. An ad may be a public service announcement or any other type of notice, such as a broadcast or a public notice published in printed or electronic press. In some implementations, an ad may be referred to or included in sponsored content.

Ads (or promotional or digital content items generally) may be communicated via various mediums and in a number of forms. In some examples, ads may be communicated through an interactive medium, such as the Internet, and may include graphical ads (e.g., banner ads), textual ads, image ads, audio ads, video ads, ads combining one of more of the foregoing formats, or any form of electronically delivered advertisement. Ads may include embedded information, such as embedded media, links, meta-information, and/or machine executable instructions. Ads also may be communicated through RSS (Really Simple Syndication) feeds, radio channels, television channels, print media, and other media.

The term “ad” can refer to both a single “creative” and an “ad group.” A creative can refer to any entity that represents one ad impression. An ad impression can refer to any form of presentation of an ad, such that the ad is viewable or receivable by a user. In some examples, an ad impression may occur when an ad is displayed on a display device of a user access device. An ad group can refer, for example, to an entity that represents a group of creatives that share a common characteristic, such as having the same ad targeting criteria. Ad groups can be used to create an ad campaign.

In some examples, ads can be embedded within other content. For example, ads can be displayed with other content (e.g., newspaper articles, weblogs, or search queries) in a web page associated with a publisher. When displayed, the ads can occupy an ad space or “block” of the web page. An ad space can refer to any element that allows information to be rendered. In some examples, the ad space may be implemented as an HTML element, such an I-Frame (inline frame) or other type of embeddable display element. The ad space can include any portion (which can include all) of a user display. The ad space can be a discrete, isolated portion of a display or the ad space can be blended and dispersed throughout a display. The ad space can be a discrete element or dispersed in multiple sub-elements. For example, ads or representations of ads displayed with search results may be displayed isolated from the actual search results. A content queue can be associated with an ad space.

With reference to FIG. 1, the online environment 100 includes one or more advertisers 102, one or more publishers 104, a content provider system (CPS) 106, and one or more user access devices 108. All of these entities may be coupled to a network 110. Each of the elements 102-110 in FIG. 1 may be implemented or associated with hardware components, software components, firmware components, or any combination of such components. The elements 102-110 can, for example, be implemented or associated with general purpose servers, software processes and engines, and/or various embedded systems. The elements 102, 104, 106, and 110 may serve, for example, as a content distribution network. While reference is made to distributing advertisements, the environment 100 can be suitable for distributing other forms of content including promotional material, search results, images, weblogs, other forms of sponsored content, publisher pages, and the like. The various components of FIG. 1 will be described in more detail below.

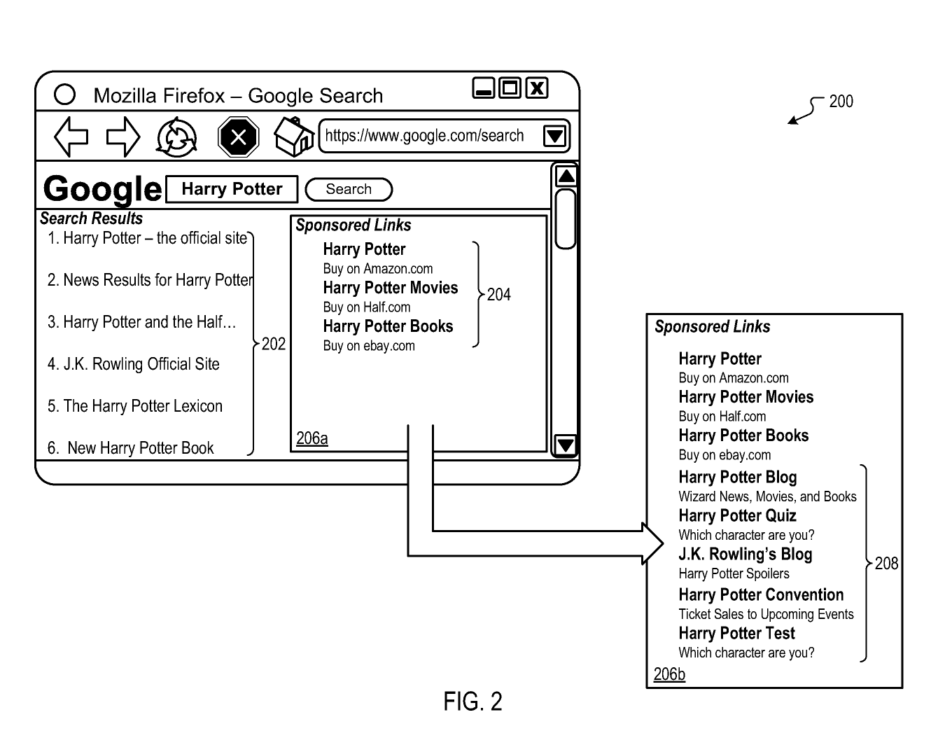

FIG. 2 is a screen shot 200 depicting example search query results 202 displayed together with promotional content items 204. The screen shot 200 illustrates an example display that may be provided by a content provider, such as the CPS 106. The display includes a user interface for a search engine, and is shown following receipt and processing of a user-entered query. For example, the CPS 106 may receive the query from a user access device 108. As shown, a user who has entered the search query “Harry Potter” has been presented with six general search results 202 and three promotional content items 204 in a sponsored links portion 206a of the display 200. The search results may be provided by the search subsystem 123, for example, and the promotional items 204 may be provided by the content serving system 120. Here, the promotional items 204 include content regarding advertising websites that sell Harry Potter paraphernalia (e.g., Amazon.com, Half.com, ebay.com). These promotional items 204 or advertisements may correspond, for example, to type-1 content items as described above, where the advertiser may provide direct financial incentive to a content provider to present the promotional content items 204, in the hopes of attracting potential customers to landing pages associated with the promotional content items 204.

However, the sponsored links portion 206a in this example also includes empty space that may provide an opportunity for display of additional digital content. For example, suppose that ad space corresponding to the sponsored links section 206a has room for eight presentations, but that only three are presently occupied. In this example, five potential presentation opportunities exist. This may occur, for example, if an insufficient number of type-1 content items meet appropriate qualifications for presentation given the received query.

In various implementations, environment 100 may supplement the ad space using type-2 content items, such as publisher pages that include an advertisement and which are affiliated with the content provider, as described above. For example, the content provider may maintain or have access to a separate index of such type-2 content items, and this index may be searched after receiving an input query. The type-2 content items may be retrieved from the index repository 126 or the publisher pages repository 113, for example.

Although only three ads are shown in the sponsored links portion 206a of the display, a number of web pages may exist which provide information about the popular fictional character “Harry Potter.” Some of these pages may include one or more advertisements, and may be affiliated with the content provider. For example, a web page may be a type-2 content item as described above, and the content provider may maintain one or more indices of type-2 web pages, such that those pages might be identified by accessing the one or more indices with an appropriate query. An appropriate query may include all or a portion of a received search request, for example, such as one or more search terms. Identification of these pages may present a monetization opportunity for the content provider, even if the opportunity may not provide direct compensation or benefit accrual for mere presentation of the page (or a representation of the page). Moreover, additional relevant and useful information may be identified in this fashion, which can improve the experience for the user on presentation of the information.

Accordingly, environment 100 can provide relevant and user-targeted promotional content, including advertisements and/or publisher pages that include an advertisement, to a search-query-providing user. In some implementations, advertisers can bid on keywords related to Harry Potter (e.g., “Harry Potter,” “Potter,” “wizard,” “wizardry,” “quidditch,” or “Hogwarts”) to encourage presentation of their ads when a user enters one of the keywords as part of a search query. If the keywords have not drawn sufficient bidding interest, or if associated advertisements fail to meet a quality threshold, a less-than-desired number of type-1 content items may be available for presentation, for example, as shown in FIG. 2 (where only three promotional content items are presented when space for eight exists). In this example, type-2 content items may be identified to fill out the ad space, if appropriate. For example, alternative sponsored links portion 206b shows a number of type-2 content representations 208 (e.g., representations of web pages that include an advertisement and are affiliated with the content provider) that have been added to the selectable ad space.

In various implementations, the additional content items 208 may be determined in an auction for the ad space for the sponsored links portion 206a. Alternatively, statistical calculation measures may be used to identify the content items 208. These techniques will be described in more detail below. In some examples, the environment 100 may supplement ad content with the most relevant or most profitable publisher pages.

In some implementations, CPS 106 can replace keyword-identified and selected (type-1) ads with more relevant or higher quality publisher pages (e.g., type-2 content). For example, CPS 106 can place the keyword selected ads and the retrieved publisher pages into an auction to determine the best candidates for rendering. The determination can be based on one or more rules. In other implementations, the publisher pages 208 may be added to the ad space because an auction was not fully sold, for example. Here, publisher pages 208 may represent content identified by content serving system 120 as relevant and/or as being of high quality. Accordingly, publisher pages 208 provide supplemental ad information to an otherwise incompletely filled ad presentation on a search engine page.

Referring again to FIG. 1, the advertisers 102 may include any entities that are associated with ads. The advertisers 102 can provide (or be otherwise associated with) products and/or services related to ads. The advertisers 102 can include or be associated with, for example, retailers, wholesalers, warehouses, manufacturers, distributors, health care providers, educational establishments, financial establishments, technology providers, energy providers, utility providers, or any other product or service providers or distributors.

The advertisers 102 may directly or indirectly generate, maintain, and/or track ads, which may be related to products or services offered by or otherwise associated with the advertisers. The advertisers 102 may include or maintain one or more data processing systems 112, such as servers or embedded systems, coupled to the network 110. The advertisers 102 may include or maintain one or more processes that run on one or more data processing systems.

The publishers 104 may include any entities that generate, maintain, provide, present and/or otherwise process content in the environment 100. The publisher “content” can include various types of web-based and/or otherwise presented information, such as, for example, articles, discussion threads, reports, analyses, financial statements, music, video, graphics, search results, web page listings, information feeds (e.g., RSS feeds), television broadcasts, radio broadcasts, or printed publications.

In some implementations, the publishers 104 may include content providers with an Internet presence, such as online publication and news providers (e.g., online newspapers, online magazines, or television websites), online service providers (e.g., financial service providers or health service providers), and the like. The publishers 104 can include television broadcasters, radio broadcasters, satellite broadcasters, and other content providers. One or more of the publishers 104 may represent a content network that is associated with the CPS 106.

In some implementations, the publishers 104 may receive requests for content from the CPS 106 or user access devices 108 (or other elements in the environment 100) and provide or present content to the requesting system or devices. The publishers may provide or present content in various forms, including web-based and non-web based forms. In some implementations, the publishers 104 may generate and/or maintain such content, or may retrieve the content from other network resources. A publisher may also receive ads or content from other publishers or from the CPS 106 for display on the publisher's site. For example, CPS 106 may provide publisher pages from a publisher page database 113 for one or more publisher websites if, for example, the publisher page content is relevant to a particular publisher's website. In various implementations, the provided content may include an advertisement.

The publishers 104 may include or maintain one or more data processing systems 114, such as servers or embedded systems, coupled to the network 110. They may include or maintain one or more processes that run on data processing systems. In some examples, the publishers 104 may include one or more content repositories 115 for storing content and other information. For example, the content repositories 115 may include indices of publisher pages, keyword links, and other metadata associated with publisher content.

In addition to content, the publishers 104 may be configured to integrate or combine retrieved content with advertisements, which may be related or relevant to the retrieved content. As discussed further below, these ads may be provided by the CPS 106 and may be combined with publisher content for display to users. In some examples, the publishers 104 may retrieve content for display on a particular user access device 108 and then forward the content to the user access device 108 along with code that causes one or more ads from the CPS 106 to be displayed to the user. In other examples, the publishers 104 may retrieve content, retrieve or receive one or more relevant ads (e.g., from the CPS 106 or the advertisers 102), and then integrate the ads and the content to form a content page for display to the user. In other implementations, content may flow from the publishers 104 to the CPS 106, where the content may be combined with an appropriate digital content item (e.g., an advertisement), and then presented to a user access device 108. In various implementations, the CPS 106 may present content received from a publisher 114 without modification to a user access device 108.

The CPS 106 manages content provision and provides various services to the advertisers 102, the publishers 104, and the user access devices 108. The CPS 106 can receive requests for information, perform one or more queries to identify relevant digital content items, and present the identified content items in an appropriate fashion. In performing the one or more queries, the CPS 106 may access one or more indices of compiled information, according to various implementations.

The CPS 106 may present promotional content in response to a received request for information, such as a received search request. For example, the CPS 106 may receive a search query from a user access device 108, and may respond by identifying and returning one or more search results and one or more promotional content items to the requesting user access device 108. Examples of such promotional content can include advertisements or web pages that include an advertisement, or representations of either (e.g., a descriptor and a selectable URL address with a link to the page). In some implementations, the CPS 106 may store ads in an ad repository 117 and facilitate distribution or targeting of ads through the environment 100 to the user access devices 108.

In this example, the CPS 106 includes one or more content serving systems 120, one or more auction subsystems 122, and one or more search subsystems 123. In general, the CPS 106 and systems or subsystems thereof may include one or more data processing systems 116, such as servers or embedded systems, coupled to the network 110. These processing systems 116 can include one or more processors that can execute instructions to perform tasks appropriate for the particular system or subsystem. The CPS 106 or systems thereof can also include one or more processes, such as server processes.

The search subsystem 123 may provide search results in response to a received search query, and may include one or more data processing systems 116 that can perform functionality associated with identifying appropriate search results. The search query can include one or more search terms, and the search subsystem 123 can use the query or terms to retrieve relevant search results from an index of compiled information, such as index 126. The index 126 can include, for example, lists of web page titles, snippets of text extracted from those web pages, and hypertext links to those web pages. The search subsystem 123 can identify and optionally rank relevant digital content items for presentation as search results. In various implementations, the search subsystem can include components that compile and maintain one or more indices, such as crawlers and index assembly and maintenance modules, for example.

The content serving system 120 may include one or more data processing systems 116 that can perform functionality associated with delivering content to publishers or user access devices. In some implementations, the content serving system 120 can also identify content appropriate for a given request, opportunity, or application. In general, the content serving system 120 may decide whether to serve certain promotional content, such as particular ads or other digital content items. This determination may consider many factors, including relevancy of the content item, quality of the content item, monetization potential of the content item, among others.

In some implementations, when making content serving decisions, the content serving system 120 may evaluate various statistical measures to determine appropriate content for presentation. The statistical measures can be used to assess monetization potential, according to some implementations, and may use compiled or historical data for one or more calculations. For example, the content serving system 120 can calculate an effective cost per 1000 impressions, referred to as effective CPM (eCPM), associated with advertisements. The eCPM can be calculated based on a cost per 1000 impressions (CPM) and a click through rate (e.g., based on statistics associated with an advertisement). For example, a first clothing ad and a second clothing ad can be compared based on respective eCPM data. Suppose the first ad receives 430 impressions and generates $3.44 in total earnings, while the second ad receives 240 impressions and generates $1.56 in total earnings over the same period of time. In some examples, the eCPM can be calculated as (total earnings*1000)/impressions. Thus, the eCPM of the first ad can be calculated as ($3.44*1000)/430=$8.00. Similarly, the eCPM of the second ad can be calculated as ($1.56*1000)/240=$6.50. In some implementations, the CPS 106 may analyze the eCPM associated with relevant ads to determine which ads should be rendered. For example, for 1,000 impressions of the first clothing ad, an expected return may be roughly $8.00. Similarly, for 1,000 impressions of the second clothing ad, an expected return may be roughly $6.50. Because the first clothing ad has a higher expected return than the second clothing ad for a given number of impressions, it may be more lucrative over time to present the first clothing ad than the second clothing ad, based on the statistical calculations.

As described above, when a user selects an ad on a web page, the advertiser associated with the ad may be charged a fee by the content provider or alternatively by a publisher. In some implementations, the content serving system 120 may maintain accounting records of the charges. The fee or price may be determined in a number of ways. One example involves using one or more auctions to set a price, which auctions may be performed prior to presentation of the content. The auction subsystem 122 can conduct the auctions, including interfacing with respective advertisers 102 who may bid in the auctions, as will be described in more detail below.

In some examples, presented content can include representations of publisher pages that include advertisements, where the respective publishers have a relationship with the content provider. A user may select one of these representations and be directed to the publisher page, for example. In some implementations, the publisher may not be charged a fee when this occurs. However, if a user viewing the publisher page selects the advertisement on the page, the content provider may accrue a benefit based on the selection activity. The benefit, which may be a monetary credit, may be the responsibility of, for example, the corresponding advertiser or the publisher.

Statistical measures may likewise be computed to assess monetization potential of these types of digital content presentation candidates. The measures may include calculations designed to predict an expected return to the content provider for serving a publisher page from a group of affiliated pages that include an advertisement covered by an agreement or relationship as described above. While a publisher may not be charged in the same way that an advertiser may be charged when publisher content is provided in an ad space, an eCPM of the supplemental publisher pages may be calculated to facilitate hierarchical ordering of the pages and ads. For example, environment 100 can determine an eCPM by estimating an expected revenue share resulting from users clicking on the content ads in the publisher's landing page. In general, the expected revenue share can be calculated using click logs, which may be maintained in association with the respective ads in various implementations. Click logs, for example, may contain information about which document was selected after searching for a keyword, and at which position in the result list the selected document was positioned. Click logs can include additional information, and may be stored in any appropriate storage location throughout the environment 100. Upon determining the expected revenue share, the environment 100 can add the new ads (i.e., publisher pages) to the existing set of candidate ads and run the standard eCPM auction, as described above.

In some examples, the content serving system 120 may decide whether to serve ads with publisher content based on bids received from advertisers. For example, the content serving system 120 may identify a relevant ad from the ad repository 117 based on keywords or placement information, but may decide that the ad should not be served with the publisher content because a particular minimum quality threshold has not been met for serving the identified ad. In some examples, these threshold decisions may be based on rules maintained by the auction subsystem 122.

The auction subsystem 122 may include one or more data processing systems 116 that can perform auctions and associated tasks to identify relevant ads for presentation, process bids, process various rules, perform filtering processes, generate reports, maintain accounts and usage information, and provide other backend system processing. In various implementations, the auction subsystem 122 can be used to conduct one or more auctions to identify or rank content for presentation. The CPS 106 can use the auction subsystem 122 and the content serving system 120 to target ads from the advertisers 102 through the publishers 104 to the user access devices 108. In some examples, the auction subsystem 122 can provide an inventory of a combination of advertisements and publisher pages for content within a search engine website (e.g., Google), a social networking website (e.g., FaceBook™ or ITV™), a video sharing website (e.g., YouTube™ or Google Video™), or other sites providing digital content.

The auction subsystem 122 can perform one, two, or more types of auctions to select advertisements or to establish fees or prices associated with advertisements. For example, the auction subsystem 122 can perform a Vickery-Clarke-Groves (VCG) auction or a Generalized Second Price (GSP) auction. The type of auction performed, in conjunction with auction participation by various auction participants, can affect the price that an advertiser pays for a particular position in the auction.

In various implementations, one, two, three, or more auction engines may be used. The auction subsystem 122 can conduct auctions with different auction bid types (e.g., VCG and GSP) by using two or more auction engines, for example. In some implementations, auctions for each bid type can be performed separately from the auction for other bid types. In some implementations, the auction subsystem 122 can receive multiple bid types and perform a hybrid auction that uses both bid types in a single auction. Accordingly, advertisers may not be required to change a bid type to participate in the hybrid auction.

In some implementations, a first auction can be conducted for candidate advertisements for presentation in response to a received search query, and a second auction can be conducted for candidate publisher pages that include one or more advertisements for presentation in response to the search query. Then, results from each auction can be used to determine an appropriate presentation set of promotional content, which may involve performing a third auction in some implementations. Alternatively, a single auction can be conducted to identify and rank candidate promotional content items, regardless of type. For example, the CPS 106 can combine the keyword content and the new inventory of publisher page content into an auction where advertisers can place bids accordingly. Alternatively, auctions may not be used, and presentation determinations can be based on statistical measures, such as those described above.

In some implementations, content items can be disqualified in an auction mechanism if the content items fall below the minimum quality threshold. This may prevent service of inappropriate content items for a given received search query, for example, even if the content items may be relevant or may have good monetization potential. In situations like this, the system may benefit by the increased number of candidate content items available for presentation, such that an ad space may be filled or more-nearly filled for a given received search query. That is, publisher pages with advertisements may be used to fill out ad spaces when an inventory of appropriate traditional advertising candidates is insufficient.

By way of example, upon receipt of a search query, the CPS 106 may attempt to fill an ad space by retrieving content from one or more sources. For example, upon receiving a user-entered query, the content serving system 120 can search an index of candidate advertisements using the received query or a portion thereof, and provide a number of ads to the auction subsystem 122. In some examples, the ads can be selected or identified from the index according to user-entered keywords and other ad criteria. Separately, the content serving system 120 can search another index of candidate publisher pages that are affiliated with the content provider (e.g., because they include an advertisement having a relation to the content provider) using the received query or a portion thereof, and provide a number of pages to the auction subsystem 122. In some implementations, the system can limit candidate identification to the affiliated publisher pages.

The auction subsystem 122 can then be used to help determine an optimum content presentation lineup. In this fashion, the CPS 106 can leverage auction capability to provide an improved promotional content lineup in response to a received search query. Coupled with presentation of traditional search results, this may enhance the experience of the user, as a wider variety of useful and relevant content may be presented.

In some implementations, a publisher page may not include quality specific data. For example, the publisher page may be new, small, or simply not yet available or registered with larger search engines. However, if the publisher registers the page for an ad program such as AdSense™ for content or DoubleClick™, for example, the page may begin to receive exposure. Specifically, environment 100 can use the ad program registration as a way to index the “new” publisher page. If the page is indexed, a large search engine website can begin to display the publisher page in ad space when the publisher page content is relevant. If the page becomes popular enough, other search engine websites can serve the publisher page content in a similar fashion.

In some examples, the CPS 106 may crawl content provided by the publishers 104 or advertisers 102 to deliver ads and/or publisher pages that are relevant to publisher sites, site content, and publisher audiences based on the crawled content. The CPS 106 may also target ads and/or publisher pages based on user information and behavior, such as particular search queries performed on a search engine website.

The CPS 106 may store campaign data in a campaign data repository 124. The campaign data can, for example, specify advertising budgets for advertisements, or when, where, and under what conditions particular advertisements may be served for presentation. For example, a shoe company may design an advertising campaign for a new line of tennis shoes that is scheduled to be released for production on March 20. The advertising campaign may have a budget of $350,000, and may have 15 different advertisements that are to be served for presentation during the month of March. Such data defining the advertisement campaign can be stored in the campaign data repository 124, and can be used in making determinations of appropriate content presentation lineups.

The CPS 106 may also store user-related information (e.g., personal profiles of users, geographic locations of users, ad context information) in a general data repository (not shown). In some examples, the CPS 106 can add search services (e.g., a Google™ search box) to a publisher site and deliver ads targeted to search results generated by requests from visitors of the publisher site. A combination of these and other approaches can be used to deliver relevant ads.

The CPS 106 may include or access an index repository 126, which may include several indices of information, including the indices described above and others, searchable by components of the system 106. The content serving system 120, the auction subsystem 122, or the search subsystem 123 may browse information (e.g., publisher pages, weblogs or discussion threads) and create copies of the browsed information in the index repository 126 for subsequent processing. In particular, the index repository 126 may include indices of crawled content and/or content received from data feeds. Other indices (not shown) may also be accessible by the systems 120, 122, 123, and may be located within the CPS 106 or alternatively outside of the CPS 106. The indices may be used to facilitate rapid retrieval of information relevant to a search query. In some implementations, an index repository of publisher pages can be created within partner network sites, such as AdSense™ or DoubleClick™ sites. For example, one or more indices may be created to include only publisher pages or other content affiliated with the CPS 106. Such an index can be queried to identify, for example, relevant digital content items for presentation in response to receipt of a search query.

In some implementations, the CPS 106 may include or access one or more crawling, surveying, and searching modules (not shown). These modules may browse accessible resources (e.g., the World Wide Web, publisher content or data feeds) to identify, survey, and store information, and build indices of searchable information as appropriate. The modules may check links, validate code, harvest information, analyze survey data, and/or perform other maintenance or other tasks. Examples of indices that may be created and maintained include an index of advertisements for which advertisers provide financial incentive to present the advertisements (e.g., type-1 content items as described above), an index of web pages that include an advertisement where the web page is associated with a page owner affiliated with the content provider system 106 (e.g., type-2 content items as described above), and one or several indices of general web content.

The CPS 106 may include one or more interface or frontend modules for providing the various features to advertisers, publishers, and user access devices. For example, the CPS 106 may provide one or more publisher front-end interfaces (PFEs) for allowing publishers to interact with the CPS 106. The CPS 106 may also provide one or more advertiser front-end interfaces (AFEs) for allowing advertisers to interact with the CPS 106. In some examples, the front-end interfaces may be configured as web applications that provide users with network access to features available in the CPS 106.

The AFEs and PFEs may include or generate physical or virtual mechanisms by which a user (or system) can input information to the CPS 106 or other system, and/or by which a user (or system) can perceive information generated by such systems. In some examples, the AFEs and PFEs may include or generate visual interfaces, such as graphical user interfaces (GUIs). Other types of interfaces can also be used. The interfaces can include one or more physical or virtual elements or widgets that allow a user (or system) to view, select, and/or indicate information.

The CPS 106 can provide various advertising management features to the advertisers 102. These features may allow users to create and configure user accounts, set account preferences, create ads, select keywords for ads, input bidding information, create campaigns or initiatives for multiple products or businesses, view reports associated with accounts, analyze costs and return on investment, target customers in different regions, target ads to particular publishers, track financial information, track ad performance, estimate ad traffic, access keyword tools, and add graphics and animations to ads.

The CPS 106 may allow the advertisers 102 to create ads and provide keywords so that the ads may be presented when the keywords are encountered. In some examples, the CPS 106 may provide ads to user access devices or publishers when keywords associated with those ads are included in a user request or requested content. The CPS 106 may also allow the advertisers 102 to set bids for ads. A bid may represent the maximum amount an advertiser is willing to pay for each ad impression, user click-through of an ad, or other interaction or activity associated with an ad. A click-through can include any action a user takes to select an ad. The advertisers 102 may also choose a currency and monthly budget.

The CPS 106 may also allow the advertisers 102 to view information about ad impressions, which may be maintained by the CPS 106. The CPS 106 may be configured to determine and maintain a number of ad impressions relative to a particular website or keyword. The CPS 106 may also determine and maintain a number of click-throughs for an ad, as well as a ratio of click-throughs to impressions. The CPS 106 may also allow the advertisers 102 to select and/or create conversion types for ads. The CPS 106 may store conversion data and other information in a conversion data repository.

The CPS 106 may similarly provide various features to the publishers 104. The CPS 106 may deliver ads (associated with the advertisers 102) to the user access devices 108 when users access content from the publishers 104, for example. The CPS 106 can be configured to deliver ads that are relevant to publisher sites, site content and publisher audiences. The CPS 106 may allow the publishers 104 to search and select specific products and services, as well as associated ads to be displayed with content provided by the publishers 104, according to some implementations. For example, the publishers 104 may search through ads in the ad repository 117 and select certain ads for display with their content.

In various implementations, the CPS 106 may be configured to provide advertisements or other promotional content included on a web page of content (e.g., a publisher page) to the user access devices 108 directly, or through the publishers 104. The CPS 106 may provide promotional content to a particular publisher 104 or a requesting user access device 108 when a user requests search results or loads content from the publisher 104, for example.

The CPS 106 can provide or target promotional content (e.g., ads) using static targeting and/or dynamic targeting. Static targeting may involve targeting ads based on some static publisher-specific placement criteria, such as by site or channel. In static or placement targeting, an entity (advertisers 102, publishers 104) can specify where ads will be served. Dynamic targeting may involve using one or more matching processes that match ads to context, geographic location, language, and other criteria. Various ranking and searching processes can also be used.

The CPS 106 may be configured to identify relevant ads for targeting using various information, such as ad size, ad keywords, content keywords, geographic information, web page identifiers, and/or content indices. As an example, the CPS 106 can receive a URL of a requested content page (e.g., from the user access device 108 or the publisher 104) and may determine user interest by matching the URL to indexed content keywords associated with the URL. The CPS 106 may then match the user interest with ads in the repository 117 or publisher pages relevant to the interest. The CPS 106 may, for example, use ad keywords from the advertisers 102 and/or other ad information to identify the ads. Such keywords may be associated with type-1 content or type-2 content, and in various implementations advertisers or other entities may or may not bid on the keywords. In some implementations, keywords can be used to identify appropriate content even if no bids are associated with the keywords. The CPS 106 can compare ad keywords from the advertisers 102 or other information to content keywords and/or content in the content page to identify relevant ads. In some examples, the ad selections and preferences specified by the publishers 104 can be used by the CPS 106 when it selects relevant ads and/or publisher pages.

The user access devices 108 may include any devices capable of receiving information from the network 110. The user access devices 108 can include general computing components and/or embedded systems optimized with specific components for performing specific tasks. Examples of user access devices include personal computers (e.g., desktop or notebook computers), mobile computing devices, cell phones, smart phones, media players/recorders, music players, game consoles, media centers, electronic tablets, personal digital assistants (PDAs), television systems, audio systems, radio systems, removable storage devices, navigation systems, set top boxes, other electronic devices and the like. The user access devices 108 can also include various other elements, such as processes running on various machines.

The network 110 may include any element or system that facilitates communications among and between various network nodes, such as elements 108, 112, 114, and 116. The network 110 may include one or more telecommunications networks, such as computer networks, telephone, or other communications networks, or the Internet. The network 110 may include a shared, public, or private data network encompassing a wide area (e.g., WAN) or local area (e.g., LAN). In some implementations, the network 110 may facilitate data exchange by way of packet switching using the Internet Protocol (IP). The network 110 may facilitate wired and/or wireless connectivity and communication.

For purposes of explanation only, certain aspects of this disclosure are described with reference to the discrete elements illustrated in FIG. 1. The number, identity, and arrangement of elements in the environment 100 are not limited to what is shown. For example, the environment 100 can include any number of geographically-dispersed advertisers 102, publishers 104, and/or user access devices 108, which may be discrete, integrated modules or distributed systems. Similarly, the environment 100 is not limited to a single CPS 106 and may include any number of integrated or distributed CPS systems or elements.

Furthermore, additional and/or different elements not shown may be contained in or coupled to the elements shown in FIG. 1, and/or certain illustrated elements may be absent. In some examples, the functions provided by the illustrated elements could be performed by less than the illustrated number of components or even by a single element. The illustrated elements can be implemented as individual processes running on separate machines or a single process running on a single machine.

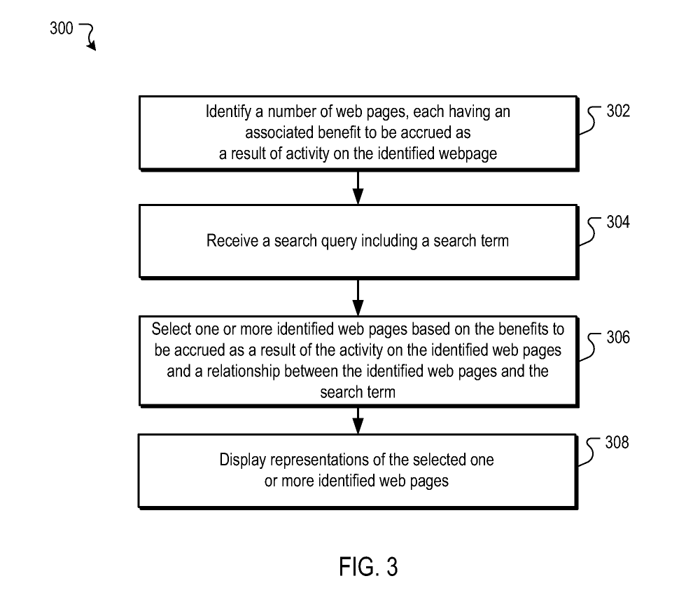

FIG. 3 is a flow diagram of an example process 300 for providing digital content. The process 300 may be used by a content provider, for example, to provide digital content in response to receipt of a search query, e.g., from a user device. The digital content may be provided for display on a display device, for example, or may be provided for storage in a memory location of a computing device, according to some implementations. The process 300 begins with identification of a number of web pages (302). Each identified web page may have an associated benefit to be accrued as a result of activity on the web page. For example, the benefit may pertain to an accrued monetary value when an activity occurs. The activity may be a user input, such as a selection, for example. The user input may include selecting or clicking on an ad, a content link, a web page, an image, a video, or other selectable media. The web page may include an advertisement or other promotional content, and the activity may be selection of the advertisement or promotional content.

In some instances, identification of the web pages can involve identifying web pages affiliated with, or having a relationship to, the content provider. In some cases, an owner or publisher of the web page may have a relationship with the content provider. The relationship may be a contractual agreement between parties associated with the content provider and a web page owner or publisher, for example. The identified web pages, or information pertaining to the web pages, can be stored in an index or multiple indices for access by the content provider.

Indices may be assembled in various ways. For example, information corresponding to an affiliated page may be added to an index of affiliated content upon instantiation of the affiliation. Such information could be included in the index when a relationship is created between the page (or owner/publisher) and the content provider, according to some implementations. In some cases, the relationship is an agreement that the content provider will be compensated (e.g., will accrue a benefit for later payment) when the activity occurs, where the activity is related to the web page or an advertisement on the web page. Meta-data associated with the web pages may be examined to identify a relationship or affiliation with the content provider, according to some implementations. The meta-data may be stored with the web pages, for example, in a storage location at the content provider or in a storage location at a publisher of the web page, for example.

The process 300 receives a search query including a search term (304). For example, a user can use an access device to enter a search query that includes search terms. An example of a search query may be “celebrity chef.” This may indicate that the user is interested in receiving information about celebrity chefs. It may also indicate that the user would be interested in receiving information on related subjects, such as, for example, food television networks, recipes, chef products, culinary schools, and so on. In various implementations, the content provider can determine a scope of information to be presented in response to the received search query.

The process 300 selects one or more of the identified web pages based on the benefits to be accrued as the result of the activity on the identified web pages, and additionally based on a relationship between the identified web pages and the search term (306). The relationship between the one or more identified pages and the search term can be, for example, that the pages are relevant to the search term (e.g., relevant to “celebrity,” “chef,” or “celebrity chef”). As another example, the relationship can be an association between the selected pages and a term related to the search term. For example, the selected pages could be associated with or related to “recipes,” “chef products,” “food television networks,” “culinary schools,” and so on. The association can be in the form of meta-data associated with the pages, and which includes one or more of the search term(s) or related terms. Keywords associated with the pages can also be reviewed and used to make the selection. In some cases the keywords may describe the page, for example, or may otherwise indicate features, parameters, or characteristics of the pages. The keywords may be included in meta-data of the pages.

The benefits accrued as a result of activity on the selected pages can correspond to a monetary credit associated with the activity. The selection can be based on an expected return associated with the web pages, according to some implementations. Different web pages may have different benefits associated therewith. For example, different benefit schemes may cover various web pages, and may result in a different benefit amount, or a different way of calculating the benefit, depending on the particular page.

In some cases, a quality of the page can be related to the benefit. For example, a higher quality page may have a first associated benefit, while a lower quality page may have a second associated benefit that may be greater than the first benefit. In some implementations, a keyword quality score can quantify a quality or relevance of a page to the particular keyword, and can be used in determining a minimum benefit, such as, for example, a minimum cost-per-click. Factors affecting the quality score can include, for example, the ad's click-through rate (CTR), relevance of the advertisement text to the keyword, historical statistics associated with the keyword or related content, and/or user experience measures for a landing page associated with the advertisement. The quality measure can be related to an advertisement or other content of the web page. A landing page quality score can represent a general quality measure of a landing page that may be provided alongside advertisements.

The quality score or scores can, for example, be used determine appropriate content for presentation. As an example, if an auction is used, the score(s) can be used to adjust bids thereof. For example, a landing page with a lower quality score can be associated with a higher minimum bid for a keyword, while a landing page with a higher quality score can be associated with a lower minimum bid for a keyword. This may incentivize publishers and advertisers to develop high-quality content, and may also improve the user experience.

The process 300 displays representations of the selected one or more of the identified web pages on a display device (308). For example, the content provider can retrieve the selected web pages from a storage location (e.g., an index or content repository) and present or serve the content to a user access device. The representations of the pages may be the pages themselves, or may be descriptions of the pages or links to the pages. In some implementations, the provided content may be supplemented with search results for the search query. Other promotional content can also be provided, such as promotional content for which an advertiser compensates the content provider for presenting or displaying the content. Other content can additionally be provided, including advertisements, publisher content, images, audio, video, and articles.

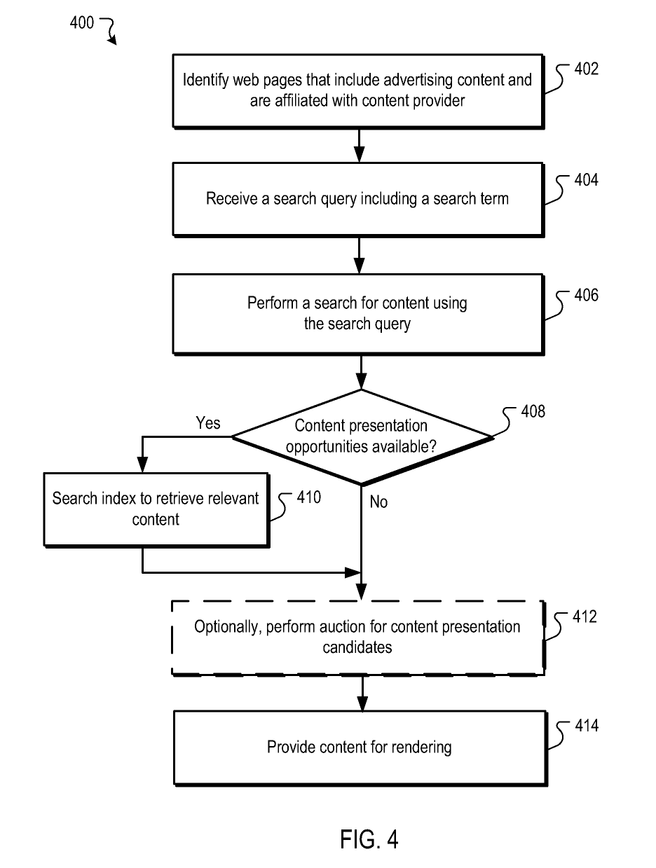

FIG. 4 is a flow diagram of another example process 400 for providing digital content. The process 400 can, for example, be executed by a digital content provider system or device. The process 400 identifies web pages that include advertising content and which are affiliated with a content provider. In an implementation, the identified web pages are publisher pages, accessible via the Internet, and maintained by a publisher that has a relationship with the content provider. One or more search indices can be created for the web pages. Search engine index creation can include collecting, parsing, and storing data associated with the pages to facilitate fast and accurate information retrieval. Designing an index may incorporate interdisciplinary concepts from linguistics, cognitive psychology, mathematics, informatics, physics, and computer science, just to name a few. The indexing may focus on full-text indexing of documents, video, audio, graphics, and other content, including advertisements. In some examples, a search subsystem or content serving system can create a search index with information on all publisher pages on the world wide web that include ads affiliated with the content provider, or with a particular advertising application (e.g., AdSense™ for search (AFS), AdSense™ for content (AFC) or DoubleClick™). The search index can be accessed to identify appropriate content pages for presentation in response to a search query. In some cases, the index can be accessed to provide content for supplementing one or more advertisements for presentation on a user access device, as in response to a received search query. For example, if an insufficient number of candidate advertisements of a first type are deemed appropriate for presentation, the index may be accessed to determine web pages that may be appropriate for presentation.

The process 400 receives a search query including a search term (404). The process 400 can then perform a search for content using the search query (406), and optionally using a quality threshold. For example, the content serving system can search the index for appropriate pages for presentation. The pages may be appropriate, for example, if they contain content relevant to the received search query or a search term thereof. For pages that are relevant, for example, a quality measure of the page or the associated advertisement may be considered, and if it meets a quality threshold, the page may be presented or considered for presentation. The quality threshold may be a predetermined score, and may be determined by the content provider, for example. In some cases, publishers, advertisers, and/or users can have input on quality threshold determination. The quality score may pertain to search terms, keywords, a landing page or publisher page, an advertisement, a publisher, an advertiser, a group of pages, ads, or other content, or any other ratable entity. In some implementations, more than one quality score may be considered. For example, a score for a publisher page and a score for an advertisement (e.g., where the scores may be also associated with a keyword) may be considered.

The process 400 can determine whether content presentation opportunities are available (408). For example, in cases where a content provider first attempts to fill ad space with advertisements, the provider can determine whether any content queue positions are available. If so, the content provider may search the index for retrieval of relevant content (410), such as web pages with advertisements and which are both affiliated with the content provider and relevant to the presentation opportunity. In some implementations, the process 400 may determine whether content presentation opportunities are available before searching for additional content.

Optionally, the process may perform one or more auctions to identify appropriate content for presentation (412). For example, one or more auctions can be held for each type of content (e.g., type-1 or type-2 content as described above) under consideration for presentation. In some cases, an auction may be held to determine a presentation lineup for content (of one type or more than one type) that is appropriate for presentation. For example, an auction subsystem can perform an auction for relevant and high quality content associated with sponsored keywords and for content including publisher pages with advertisements. In some implementations, the auction can determine which of the candidate content items has the highest monetization potential. In some implementations, the auction can determine which of the candidate content items has the highest expected return. In some implementations, the auction can determine which of the candidate content items is most relevant to a presentation opportunity. The candidate items can be ranked according to one or more measures in some implementations. In some implementations, statistical measures can be used to determine a content presentation lineup. Statistical measures can be used in lieu of, or in conjunction with, one or more auctions, for example.

The process 400 provides the content for rendering (414). A content queue can be populated with representations of most appropriate content items, or with the items themselves. The content items or representations can be served for display on a display device of a user access device, for example.

FIGS. 3 and 4 are examples only and are not intended to be restrictive. Other data flows may therefore occur in the environment 100 and, even with the data flows 300 and/or 400, the illustrated events and their particular order in time may vary. Further, the illustrated events may overlap and/or may exist in fewer steps. Moreover, certain events may not be present and additional and/or different events may be included.

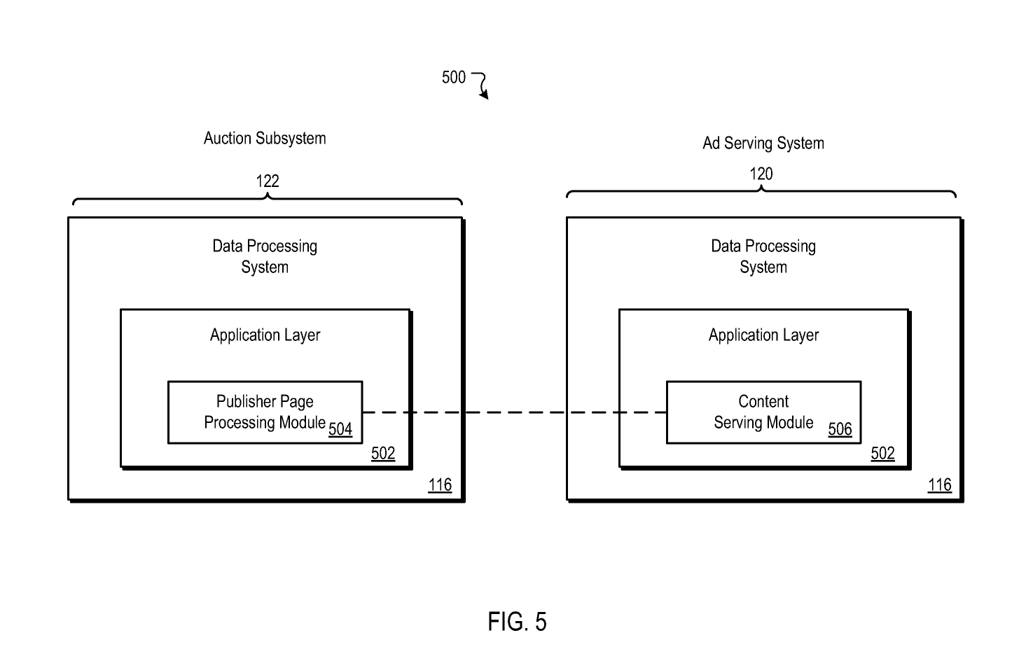

FIG. 5 is a block diagram of an example promotional content management system 500. The system 500 represents an example configuration of one or more application layers 502 of one or more data processing systems 116 maintained by the CPS 106. As illustrated in FIG. 5, the system 500 includes a publisher page processing module 504, which may be located in the auction subsystem 122. The system 500 also includes a content serving module 506, which may be located in the content serving system 120. The configuration of FIG. 5 is merely an example implementation, and the functionality of the publisher page processing module 504 and the content serving module 506 can both be distributed or exist in more or less modules than what is illustrated in FIG. 5. In some implementations, the modules 504 and 506 can be distributed among various serving systems or backend systems.

The publisher page processing module 504 may be configured to create, modify, and maintain indices filled with publisher page data, advertising data, campaign data, and other content-associated information. In addition, the publisher page processing module 504 can determine whether a bid associated with an identified ad or publisher page exceeds a quality threshold. In some implementations, the publisher page processing module 504 may provide supplemental ads or publisher pages to a particular auction.

In some examples, two or more phases of content identification are performed. For example, after receipt of a search query, the CPS 106 may first attempt to identify type-1 content for presentation. The content serving system 120 and auction subsystem 122 may work together or separately to identify such content. If a sufficient number of appropriate type-1 content items are identified to fill a content queue associated with the presentation opportunity, the identified type-1 content may be presented. However, if an insufficient number of appropriate type-1 content items are identified, a second phase of content identification may be entered. In the second phase, the CPS 106 may attempt to identify type-2 content for presentation. The content serving system 120 and auction subsystem 122 may work together or separately to identify such content.

As an example, suppose a search query such as “fresh produce” may be associated with ten ads (e.g., type-1 ads) from advertisers, and that each ad has an associated quality level or score. If five of the ten ads do not meet a minimum quality threshold level, the publisher page processing module 504 can provide supplemental publisher pages for the five ads that did not meet the minimum quality threshold. In some examples, the supplemental content may exceed the minimum quality threshold.

The content serving module 506 may be configured to provide ad content and publisher pages selected in an auction process. In some implementations, the content serving module 506 can combine the requested content with one or more of the ads provided by the system 100 or 500. The combined content and ads can be sent to the user device 108 that requested the content for presentation in a viewer (e.g., a browser or other content display system). The content serving module 506 can transmit information about the ads back to the ad server, including information describing how, when, and/or where the ads are to be rendered (e.g., in HTML or JavaScript™).

The modules 504 and 506 may include and/or use one more data structures as well as one or more computational algorithms that may operate on various data. The modules 504 and 506 may include one or more sets of instructions for performing various tasks, and both modules can output information for use by users or other systems. In some implementations, the modules 504 and 506 may include one or more engines, which may output code (e.g., source code or HTML) that serves as input to other systems, engines or processes. The modules 504 and 506 may be implemented using various programming or other languages suitable for controlling behavior of a system. In some examples, the modules 504 and 506 may be implemented using one or more of C/C++, Java, Visual Basic, eXtensible Markup Language (XML), HTML, and other languages.

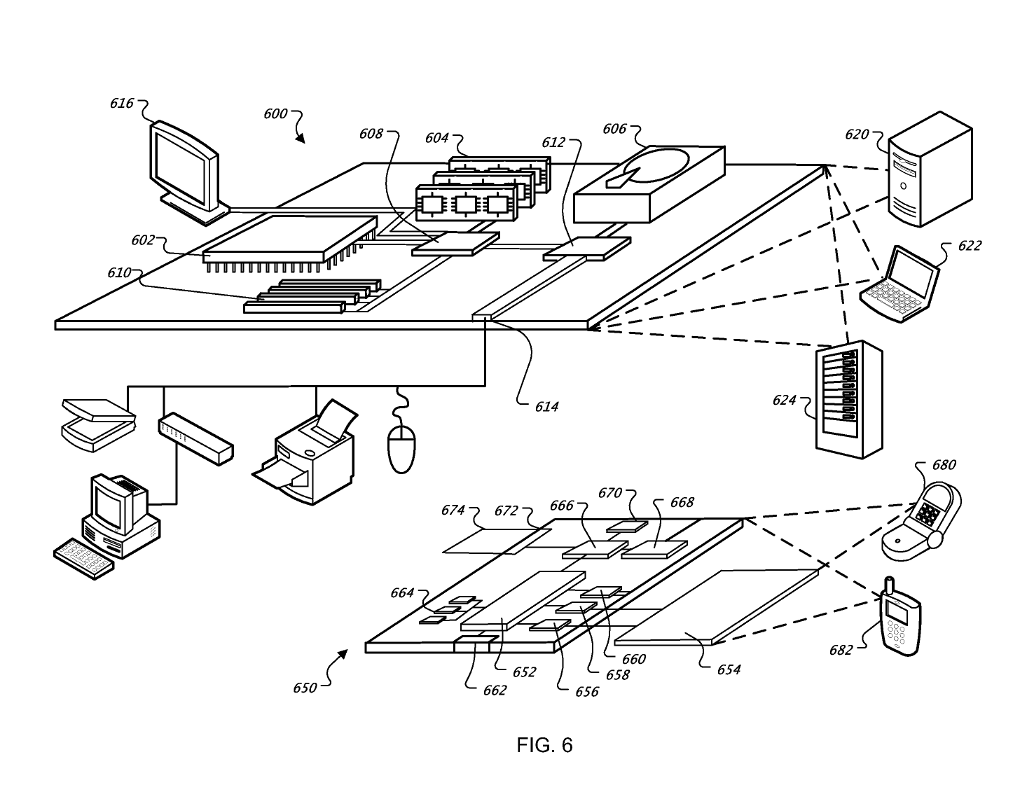

FIG. 6 shows an example of a generic computer device 600 and a generic mobile computer device 650 that may be used to implement the systems and methods described in this document, as either a client or as a server or plurality of servers. The devices or components shown in FIG. 1, for example, may be implemented with one or more of the generic computer device 600 or the generic mobile computer device 650, according to some implementations. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the systems, methods, devices or techniques described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a computer-readable medium. In one implementation, the memory 604 is a volatile memory unit or units. In another implementation, the memory 604 is a non-volatile memory unit or units.

The storage device 606 is capable of providing mass storage for the computing device 600. In one implementation, the storage device 606 is a computer-readable medium. In various different implementations, the storage device 606 may be a floppy disk device, a hard disk device, an optical disk device, a tape device, a flash memory or other similar solid-state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 604, the storage device 606, memory on processor 602, or a propagated signal.

The high speed controller 608 manages bandwidth-intensive operations for the computing device 600, while the low speed controller 612 manages lower-bandwidth-intensive operations. Such allocation of duties is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 652, 664, 654, 666, and 668, are interconnected using various buses, and several of the components may be mounted on a common motherboard or in other manners as appropriate.

The processor 652 can process instructions for execution within the computing device 650, including instructions stored in the memory 664. The processor may also include separate analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to the display 654. The display 654 may be, for example, a TFT LCD display or an OLED display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provided in communication with processor 652, so as to enable near-area communication of device 650 with other devices. External interface 662 may provide, for example, for wired communication (e.g., via a docking procedure) or for wireless communication (e.g., via Bluetooth or other such technologies).

The memory 664 stores information within the computing device 650. In one implementation, the memory 664 is a computer-readable medium. In one implementation, the memory 664 is a volatile memory unit or units. In another implementation, the memory 664 is a non-volatile memory unit or units. Expansion memory 674 may also be provided and connected to device 650 through expansion interface 672, which may include, for example, a SIMM card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, memory on processor 652, or a propagated signal.

Device 650 may communicate wirelessly through communication interface 666, which may include digital signal processing circuitry as appropriate. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS receiver module 670 may provide additional wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages or music files) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback), and input from the user can be received in any form, including acoustic, speech, or tactile input.

The systems and techniques described here can be implemented in a computing system that includes a back-end component (e.g., a data server), or that includes a middleware component (e.g., an application server), or that includes a front-end component (e.g., a client computer having a graphical user interface or a web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

The foregoing description does not represent an exhaustive list of all possible implementations consistent with this disclosure or of all possible variations of the implementations described. A number of implementations have been described. Nevertheless, it will be understood that various modifications may be made without departing from the spirit and scope of the systems, devices, methods and techniques described here. For example, various forms of the flows shown above may be used, with steps re-ordered, added, or removed. Accordingly, other implementations are within the scope of the following claims.

What is claimed is:

1. A computer-implemented method of providing digital content, the method comprising:
identifying a plurality of web pages, each of the identified web pages having an associated benefit to be accrued as a result of activity by a user on the identified web page;
receiving a search query comprising a search term and selecting one or more of the identified web pages based on the benefits to be accrued as the result of the activity on the identified web pages and a relationship between the identified web pages and the search term; and
displaying on a display device representations of the selected one or more of the identified web pages.

2. The computer-implemented method of claim 1, wherein each of the identified web pages includes an advertisement, and wherein the activity on the identified web page comprises an action associated with the advertisement.

3. The computer-implemented method of claim 2, wherein the advertisement is a selectable advertisement, and wherein the activity is a selection of the selectable advertisement.

4. The computer-implemented method of claim 1, further comprising maintaining an index of the identified web pages.

5. The computer-implemented method of claim 4, wherein selecting one or more of the identified web pages comprises searching the index and identifying web pages relevant to the search term.

6. The computer-implemented method of claim 1, further comprising displaying on the display device, separate from the representations of the selected one or more of the identified web pages, search results for the search query.

7. The computer-implemented method of claim 1, wherein the relationship between the selected one or more of the identified web pages and the search term comprises relevancy.

8. The computer-implemented method of claim 1, further comprising identifying a plurality of digital content items, each having an associated benefit that is accrued as a result of displaying the digital content item.

9. The computer-implemented method of claim 8, wherein each of the digital content items has an associated quality score, and further comprising determining whether the associated quality score for a predetermined number of the digital content items exceeds a minimum quality score associated with a presentation opportunity, wherein the predetermined number is a number of positions associated with a content queue for the presentation opportunity.

10. The computer-implemented method of claim 9, wherein the representations of the selected one or more of the identified web pages are used to fill any content queue positions not filled by the digital content items.

11. A system, comprising:
a content identification module configured to identify a plurality of web pages, each of the identified web pages having an associated benefit to be accrued as a result of activity by a user on the identified web page; and
a content serving module configured to:
receive a search query comprising a search term;
select one or more of the identified web pages based on the benefits to be accrued as the result of the activity on the identified web pages and a relationship between the identified web pages and the search term; and
display on a display device representations of the selected one or more of the identified web pages.

12. The system of claim 11, wherein each of the identified web pages includes an advertisement, and wherein the activity on the identified web page comprises an action associated with the advertisement.

13. The system of claim 12, wherein the advertisement is a selectable advertisement, and wherein the activity is a selection of the selectable advertisement.

14. The system of claim 11, wherein the content identification module is further configured to maintain an index of the identified web pages.

15. The system of claim 14, wherein selecting one or more of the identified web pages comprises searching the index and identifying web pages relevant to the search term.

16. The system of claim 11, further comprising a search results module configured to identify search results for the search query, and wherein the content serving module displays on the display device, separate from the representations of the selected one or more of the identified web pages, the search results for the search query.

17. The system of claim 11, wherein the relationship between the selected one or more of the identified web pages and the search term comprises relevancy.

18. The system of claim 11, wherein the content serving module is further configured to identify a plurality of digital content items, each having an associated benefit that is accrued as a result of displaying the digital content item.

19. The system of claim 18, wherein each of the digital content items has an associated quality score, and wherein the content serving module is further configured to determine whether the associated quality score for a predetermined number of the digital content items exceeds a minimum quality score associated with a presentation opportunity, wherein the predetermined number is a number of positions associated with a content queue for the presentation opportunity.

20. The system of claim 19, wherein the representations of the selected one or more of the identified web pages are used to fill any content queue positions not filled by the digital content items.

21. A computer-implemented method of providing digital content, the method comprising:
identifying a plurality of web pages, each of the identified web pages having an associated benefit to be accrued as a result of activity by a user on the identified web page;
receiving a search query comprising a search term;
means for selecting one or more of the identified web pages based on the benefits to be accrued as the result of the activity on the identified web pages and a relationship between the identified web pages and the search term; and
displaying on a display device representations of the selected one or more of the identified web pages.
